(19) United States
(12) Patent Application Publication
(10) Pub. No.: US 2011/0189366 A1
(43) Pub. Date: Aug. 4, 2011

(54) METHOD FOR MODIFYING TASTE WITH ESSENTIAL OIL FRACTIONS

(75) Inventors: Ruowei Zhu Thorne Strange, Katonah, NY (US); Glenn Roy, Beacon, NY (US)

(73) Assignee: PepsiCo North America, Valhalla, NY (US)

(21) Appl. No.: 12/696,967

(22) Filed: Jan. 29, 2010

(51) Int. Cl. A23L 1/09

(52) U.S. Cl. 426/533; 426/387

(57) ABSTRACT

A method for ameliorating organoleptic and sensate properties and characteristics imparted to a product by natural high-potency sweetener. A fraction of an essential oil that boils and is recovered from the vapors at a temperature between about 50° C. and about 70° C. and at pressure between about 100 Pa and 1500 Pa, or at a temperature between about 110° C. and about 130° C. and at pressure between about 100 Pa and 1500 Pa, is added to the product.

### FIELD OF THE INVENTION

The invention relates to a method for modifying tastes with essential oil fractions. In particular, the invention relates to a method for modifying the taste of compositions comprising sweeteners by addition of a fraction of essential oils.

### BACKGROUND OF THE INVENTION

Products that require a taste accepted by a consumer include products of the food, beverage, personal care, and pharmaceutical industries, for example. Sweeteners often are used in these products. Standard caloric sweeteners such as sugars and honey long have been used in such products. However, sugars such as fructose, sucrose, and glucose, introduce calories but typically offer little nutrition. Therefore, many consumers seek to substitute products having natural high-potency sweeteners for products containing these standard caloric sweeteners. Examples of natural high-potency sweeteners include stevia, stevioside, the rebaudiosides, and the dulcosides.

Although selection of a specific sweetener for a particular product often is a matter of taste, consumers generally seek the sweetening taste imparted by the standard caloric sweeteners. However, many consumers seek to reduce caloric intake by using high-potency sweeteners, but few if any of these sweeteners impart the same flavor to a composition as do the standard caloric sweeteners.

Consumers typically perceive natural high-potency sweeteners as imparting tastes, such as bitter, metallic, and astringent tastes; lingering and licorice aftertastes; and other effects, such as a cooling sensation and delayed onset sweetness, different from tastes imparted by standard caloric sweeteners. Consumers also report that natural high-potency sweeteners often fail to provide the same sensate properties and characteristics as the standard caloric sweeteners. For example, consumers typically find that mouthfeel is lacking, particularly in frozen beverages. Similarly, the sweetness of some of these sweeteners is perceived to diminish with repeated tastes.

Artificial high-potency sweeteners also tend to impart tastes different from tastes imparted by standard caloric sweeteners. Artificial high-potency sweeteners tend to introduce many of the same types of different tastes natural high-potency sweeteners impart.

Therefore, there exists a need for a method for modifying the tastes of compositions containing natural high-potency sweeteners to ameliorate the undesired organoleptic properties and characteristics imparted by these sweeteners and to enhance the desired properties and characteristics. There also exists a need for a method for modifying the tastes of compositions containing artificial high-potency sweeteners to ameliorate the undesired organoleptic properties and characteristics imparted by these sweeteners and to enhance the desired properties and characteristics.

### BRIEF SUMMARY OF THE INVENTION

A first embodiment of the invention is directed to modifying the taste of sweetened compositions by addition of a fraction or fractions of essential oil.

A second embodiment of the invention is directed to modifying the taste of sweetened compositions by addition of a combination of fractions of essential oils.

A third embodiment of the invention is directed to modifying the taste of sweetened compositions by addition of a fraction or fractions of essential oil that imparts selected properties and characteristics.

A further embodiment of the invention is directed to modifying the taste of sweetened compositions by addition of a combination of fractions of essential oils that impart different selected properties and characteristics.

A still further embodiment of the invention is directed to modifying the taste of sweetened compositions by addition of a selected compound found in a fraction of essential oils.

Another embodiment of the invention is directed to modifying the taste of sweetened compositions by addition of combinations of selected compounds found in a fraction of essential oils.

Yet another embodiment of the invention is directed to modifying the taste of sweetened compositions by addition of a selected compound found in a fraction of essential oils that imparts selected properties and characteristics.

Still another embodiment of the invention is directed to modifying the taste of sweetened compositions by addition of selected compounds found in a fraction of essential oils, each imparting different selected properties and characteristics.

### DETAILED DESCRIPTION OF THE INVENTION

Embodiments of the invention are directed to modifying taste with an essential oil fraction. In particular, embodiments of the invention are directed to modifying the taste of sweetened compositions with an essential oil fraction.

As the skilled practitioner recognizes, consumers typically characterize compositions sweetened with natural high-potency sweeteners as having different organoleptic properties and characteristics as compared with compositions sweetened with standard caloric sweeteners. Consumers also have identified sensate properties and characteristics, such as mouthfeel, that often are lacking in, or at least different from, the sensate properties and characteristics of compositions sweetened with standard calorie sweeteners.

The inventors have discovered that these properties and characteristics can be ameliorated in a composition containing natural high-potency sweetener by addition to the composition of an essential oil fraction, thus imparting to the product a taste that has fewer or diminished differences from the taste of product sweetened with standard caloric sweetener. The inventors have discovered that addition of an essential oil fraction ameliorates differences in taste introduced by the natural high-potency sweetener. These differences include, but are not limited to, bitter, metallic, and astringent tastes; lingering and licorice aftertastes; and other effects, such as a cooling sensation, a delayed onset sweetness, a lack of mouthfeel or smoothness, and a perception of diminished sweetness with repeated ingestions.

The inventors have discovered that these properties and characteristics also can be ameliorated in a composition containing artificial high-potency sweetener by addition to the composition of an essential oil fraction, thus imparting to the product a taste that has fewer or diminished differences from the taste of product sweetened with standard caloric sweetener. The inventors have discovered that addition of an essential oil fraction ameliorates differences in taste introduced by the artificial high-potency sweetener. For convenience, the invention will be described herein as it relates to natural high-potency sweeteners.

Many compositions that are products of the food, beverage, personal care, and pharmaceutical industries are sweetened. Natural high-potency sweeteners often are used in these compositions. Both liquid and solid compositions are within embodiments of the invention. These compositions may be eaten or imbibed and swallowed, or may be taken into the mouth, then expectorated. The composition may contain alcohol.

Non-limiting examples of liquid compositions that may comprise natural high-potency sweeteners include non-carbonated and carbonated beverages such as colas, ginger ales, root beers, ciders, fruit-flavored soft drinks (e.g., citrus-flavored soft drinks such as lemon-lime or orange), and drinks made by adding water to a powder or concentrate (e.g., cola, juice, tea, flavoring for water, coffee, and ades). Other examples include fruit juices of all types, including beverages and ades containing juice or fruit particles, such as lemonade, vegetable juices, and mixed juices containing fruits and vegetables. Additional examples include sport drinks, energy drinks, water with natural or artificial flavorants, tea and tea-containing beverages, coffee and coffee-containing beverages, and cocoa.

Dairy beverages also may be sweetened, and may contain other components. Such beverages include milk, half and half, and cream, drinkable yogurt, lactic acid bacteria beverages, and beverages containing milk components such as coffee containing dairy components, cafe au lait, and tea with milk. Combination beverages, such as fruit milk beverages, smoothies, milk shakes, frappes, and malts, also often are sweetened.

Beverage creamers also may be sweetened with natural high-potency sweetener. Such creamers may be dairy-based or non-dairy based, and are used to lighten beverages such as coffee and tea. Often, these creamers contain flavors, such as chocolate, mint, nut, orange, and vanilla, and sweeteners.

Aqueous solutions used to make beverages by addition of alcohol, or which already contain alcohol and so are ‘ready-to-drink,’ also may be sweetened with natural high-potency sweetener. The non-alcoholic solutions typically provide all ingredients necessary to make an alcoholic drink, such as a ‘mojito,’ a ‘mai tai,’ or a ‘tom collins,’ for example.

Frozen and cold confections, such as beverages that are made by mixing a sweetened liquid composition with or pouring a sweetened liquid composition over particulate ice, such as a ‘snow cone,’ or by dispensing a pressurized, carbonated sweetened liquid solution or a supercooled sweetened liquid solution to form a frozen confection, also are examples of sweetened liquid compositions. Frozen alcoholic beverages are made from sweetened liquid compositions.

Liquid pharmaceuticals and nutraceuticals also may be sweetened with natural high-potency sweeteners. Vitamins, cough syrups, liquid amino acids, and bitter-tasting liquid medicines are exemplary. Mouth freshening agents, gargles, mouth rinsing agents, mouth sprays, liquid teeth-whitening agent, and dietary supplements are examples of personal care products that often are sweetened.

Embodiments of the invention include modifying the taste of compositions comprising natural high-potency sweeteners. As used herein, the phrase “natural high-potency sweetener” means any sweetener found in nature which may be in raw, extracted, purified, treated enzymatically, or any other form, singularly or in combination, and characteristically has a sweetness potency greater than sucrose, fructose, or glucose, yet has fewer calories. Non-limiting examples of natural high-potency sweetener suitable for embodiments of this invention include rebaudioside A, rebaudioside B, rebaudioside C (dulcoside B), rebaudioside D, rebaudioside E, rebaudioside F, dulcoside A, rubusoside, stevia, stevioside, mogroside IV, mogroside V, Luo Han Guo sweetener, siamenoside, neoastilbin, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, and cyclocarioside I. The rebaudiosides often are abbreviated ‘Reb,’ so, for example, rebaudioside A also is known as ‘Reb A.’ These terms are used interchangeably herein.

“Natural high-potency sweetener” also includes modified natural high-potency sweeteners, i.e., natural high-potency sweeteners that have been altered naturally. For example, a modified natural high-potency sweetener includes, but is not limited to, natural high-potency sweeteners that have been fermented, contacted with enzyme, or derivatized or substituted on the natural high-potency sweetener.

Artificial high potency sweeteners that may impart tastes that are different from tastes of standard sweetener compositions include, but are not limited to, sucralose, acesulfame potassium (“aceK”) or other salts, aspartame, alitame, saccharin, neohesperidin dihydrochalcone, cyclamate, neotame, N-[N-[3-(3-hydroxy-4-methoxyphenyl)propyl]-L-alpha-aspartyl]-L-phenylalanine 1-methyl ester, N-[N-[3-(3-hydroxy-4-methoxyphenyl)-3-methylbutyl]-L-alpha-aspartyl]-phenylalanine 1-methyl ester, N-[N-[3-(3-methoxy-4-hydroxyphenyl)propyl]-L-alpha-aspartyl]-L-phenylalanine 1-methyl ester, and salts thereof.

The inventors have discovered that the different organoleptic and sensate properties and characteristics imparted by natural high-potency sweetener are ameliorated by addition to a composition sweetened with natural high-potency sweetener of a fraction of essential oil. Addition of this fraction of essential oil in embodiments of the invention reduces different tastes and effects often perceived by consumers in compositions thus-sweetened, enhances sweetness, and imparts smooth, full mouthfeel. Embodiments of the invention also are directed to addition of a combination of fractions of essential oil from one or more essential oils.

Essential oil used in embodiments of the invention typically is plant oil. Essential oils often are classified by the primary organoleptic characteristic imparted by the essential oil. Typical classifications include floral, woody, mossy, fruity (including citrus, tropical, and other subclassifications), minty, spicy, leafy/green, herbal, and resin/incense. Other classification systems are used. Many essential oils and fractions thereof are characterized as falling within more than one such classification. Such fractions may be considered for use in embodiments of the invention for the contribution of any of the organoleptic characteristics, and typically is used for the organoleptic characteristic that predominates under conditions of use. However, embodiments of the invention contemplate using such a fraction for the less-predominant organoleptic characteristic. With the guidance provided herein, the skilled practitioner can identify, select, and use distilled fractions in accordance with embodiments of the invention.

Essential oils can be obtained from many plants. Examples of plants from which oils are obtained include sandalwood, eucalyptus, clary sage, labdanum, olibanum, and fruit trees. Essential oils can be obtained from virtually any part of the plant, including the wood, bark, leaf, fruit, and flower.

Essential oil obtained from a plant may vary in composition from season to season, and may depend upon the region in which the plant is grown. Therefore, it is difficult if not impossible to set forth a standard composition for essential oils. Similarly, the exact effect of addition of an essential oil may not be duplicated identically when, for example, essential oils from different sources are utilized. However, the basic organoleptic characteristic imparted typically remains the same from sample to sample.

Fractions of essential oil added to products sweetened with natural high-potency sweetener in embodiments of the invention are obtained by fractionation of essential oil at an absolute pressure between about 100 Pa and 1500 Pa, typically between about 100 Pa and 500 Pa, and more typically between about 100 Pa and 150 Pa. Fractions of essential oil in two boiling ranges, if available from the essential oil, can be employed in embodiments of the invention. A first fraction comprises sesquiterpenes and co-distillates that boil and are recovered from the vapors at a temperature between about 50° C. and about 70° C., typically between about 50° C. and about 65° C., more typically between about 55° C. and about 65° C., and most typically between about 60° C. and about 65° C. A second fraction comprises oxygenated sesquiterpenes and co-distillates that boil and are recovered from the vapors at a temperature between about 110° C. and about 130° C., more typically between about 115° C. and about 125° C. A suitable essential oil may comprise one or both of these fractions, i.e., may comprise sesquiterpenes, sesquiterpene alcohols, or both.

Sesquiterpenes are a class of terpenes that consist of three isoprene units and have the molecular formula C₁₅H₂₄. As used herein, oxygenated sesquiterpenes also are known as sesquiterpene alcohols, and are alcohols that have 15 carbon atoms, a hydroxyl moiety, and a number of hydrogen atoms that is related to the degree of unsaturation and the number of cyclic rings in the molecule. As the skilled practitioner recognizes, sesquiterpene alcohols have at least one cyclic ring, and typically have between 1 and 3 cyclic rings. Also, sesquiterpene alcohols typically are unsaturated, but may be saturated. Therefore, the formula of a sesquiterpene alcohol may be C₁₅H₂₈O, C₁₅H₂₇O, C₁₅H₂₆O, C₁₅H₂₅O, C₁₅H₂₄O, C₁₅H₂₃O, C₁₅H₂₂O, or may have fewer hydrogen atoms. Typically, sesquiterpene alcohols have the formula C₁₅H₂₆₋ₓO, wherein x ranges from 0 to 4. The value of x is related to the degree of unsaturation (number of double bonds) and the number of cyclic rings in the molecule. As the skilled practitioner recognizes, the number of hydrogen atoms in a molecule decreases as the degree of unsaturation increases and as the number of cyclic rings increases. The skilled practitioner can, with the guidance provided herein, determine the value of x for a sesquiterpene alcohol compound.

The co-distillates may contain an insignificantly small fraction of diols. The skilled practitioner recognizes that it is difficult to determine whether and how much diol is in an essential oil or fraction thereof.

Although the inventors do not wish to be bound by theory, it is believed that distilling an essential oil to recover a fraction or cut distilling above about 50° C. removes the lighter components that may introduce aromas. Typically, aromas are not included as part of embodiments of the invention. Also, coumarins and psoralens do not make up a significant part of a fraction of essential oil derived from a citrus source by fractionation at a pressure between about 100 Pa and about 1500 Pa and at a temperature between about 50° C. and about 70° C. Essentially no sesquiterpene alcohols were identified in the fraction of bergamot distilled at a temperature between about 110° C. and 130° C. Coumarins and psoralens would contribute unwanted aromas to product made in accordance with embodiments of the invention.

As used herein, the phrases “fraction of essential oil” and “distilled fraction” refer to the fractions of essential oil that boil and are recovered from the vapors at a pressure between about 100 Pa and 1500 Pa, typically between about 100 Pa and about 500 Pa, and more typically between about 100 Pa and 150 Pa, and at a temperature between about 50° C. and about 70° C., typically between about 50° C. and about 65° C., more typically between about 55° C. and about 65° C., and most typically between about 60° C. and about 65° C. or at a temperature between about 110° C. and about 130° C., more typically between about 115° C. and 125° C. The phrases “sesquiterpenes with co-distillates” and “sesquiterpene fraction” refer to the lower-boiling fractions of essential oil, and the phrases “sesquiterpene alcohols with co-distillates,” “oxygenated sesquiterpenes with co-distillates,” and “sesquiterpene alcohol fraction” refer to the higher-boiling fractions.

Embodiments of the invention are directed to addition of a single fraction of essential oil to a product sweetened with a natural high-potency sweetener that exhibits properties and characteristics imparted by the natural high-potency sweetener that consumers typically identify as not the same as properties and characteristics imparted by standard caloric sweetener. The fraction may be the sesquiterpene fraction or the sesquiterpene alcohol fraction.

In embodiments of the invention, a fraction of essential oil imparting organoleptic characteristics selected from the woody and fruity classifications typically is added to a product sweetened with a natural high-potency sweetener. More typically, a fraction of essential oil imparting organoleptic characteristics selected from the fruity classification is selected from the citrus fruit and tropical fruit sub-classifications.

Other embodiments of the invention are directed to addition of a combination of fractions of essential oils selected from the same classification. Thus, embodiments of the invention are directed to combinations of distilled fractions from the same classification of organoleptic characteristic, such as woody, mossy, or fruity. Embodiments of the invention wherein a combination of fractions is used may comprise both the sesquiterpene fraction and the sesquiterpene alcohol fraction from one essential oil, the same distilled fraction from different essential oils, or different distilled fractions from different essential oils.

In particular, the fraction of essential oils imparting woody organoleptic characteristics selected from sandalwood, patchouli, clary sage, eucalyptus, and labdanum typically is used in embodiments of the invention, with a distilled fraction sandalwood essential oil most typically added. Typically, a sesquiterpene alcohol fraction of sandalwood is selected.

In other embodiments of the invention in which the fraction of essential oil imparting a fruity organoleptic characteristic is selected, tropical fruit organoleptic characteristics typically include pineapple and guava, with typical citrus organoleptic characteristics selected from bergamot and olibanum. Typically, a sesquiterpene fraction of bergamot is selected.

Other embodiments of the invention are directed to addition of a combination of fractions from more than one classification. In these embodiments of the invention, a fraction of essential oil that imparts an organoleptic characteristic from a first classification and a fraction of essential oil that imparts an organoleptic characteristic from a second classification are combined. Any combination of organoleptic characteristics can be imparted in embodiments of the invention. A combination of a fraction of essential oil imparting a woody organoleptic characteristic and a fraction of essential oil imparting a fruity organoleptic characteristic more typically is used in embodiments of the invention. Most typically, a combination of sesquiterpene alcohol fraction of sandalwood and sesquiterpene fraction of bergamot is added to a product comprising a natural high-potency sweetener in accordance with embodiments of the invention.

The sesquiterpene fraction of bergamot imparts a strong woody organoleptic characteristic with a less-strong citrusy organoleptic characteristic. Also, although the inventors do not wish to be bound by theory, sesquiterpenes hydrate over time in solution having a pH below about 4, and even more typically below about 3.5. Beverages such as soft drinks typically have a pH below about 3.5. In an acidic beverage, the sesquiterpenes in the fraction will hydrate to form ethers, alcohols, and other cyclic materials. Typically, the sesquiterpenes hydrate to form sesquiterpene alcohols. In particular, sesquiterpenes in a bergamot sesquiterpene fraction will hydrate to the alcohol form, i.e., sesquiterpene alcohols. These sesquiterpene alcohols impart a woody organoleptic characteristic. Therefore, these sesquiterpenes continue to impart a woody organoleptic characteristic, but the citrusy or other contribution may decrease with time.

The skilled practitioner recognizes that any hydration that occurs, for example under acidic conditions, proceeds at a rate that increases as the pH decreases and as the temperature increases. For example, at a pH of 2.5 and a temperature of 40° C., the rate of reaction is approximately double that when the pH is 2.5 and the temperature is 30° C.

The inventors also have discovered that addition to a product comprising natural high-potency sweetener of a sesquiterpene or of a sesquiterpene alcohol ameliorates the different organoleptic and sensate properties and characteristics imparted by the natural high-potency sweetener. Tables 1 and 2 below exemplify suitable sesquiterpenes and sesquiterpene alcohols for use as single compounds in embodiments of the invention, together with their approximate boiling points at atmospheric pressure.

The boiling points in the tables are at atmospheric pressure. However, the skilled practitioner recognizes that there are well-known methods by which the boiling point at reduced pressure can be estimated. For example, there are many generalized techniques, such as application of the Clausius-Clapeyron equation, to estimate the boiling point of a liquid at a pressure if the boiling point of that liquid at another pressure is known. As the skilled practitioner recognizes, the Clausius-Clapeyron equation assumes a constant heat of vaporization over the pressure range. A more precise estimate can be obtained by application of Antoine's equation, which uses empirical data for the compound in question. Using these or other techniques, one can determine that the boiling point of the santalols is 115° C. at 106 Pa. With the guidance provided herein, the boiling points of the other compounds at reduced pressure can be obtained by the skilled practitioner.

TABLE 1
Sesquiterpenes

| Sesquiterpene | B Pt, ° C. at 1 atm. |
|---|---|
| Alpha- and beta-bergamotene | 258-260 |
| Alpha-bisabolene | 261-263 |
| Beta-bisabolene | 274-275 |
| Alpha-bourbonene | 254-256 |
| Cadinene | 261-262 |
| Beta-caryophyllene | 260-261 |
| Alpha-copaene | 246-251 |
| Beta-cubebene | 283 |
| Beta-elemene | 251-253 |
| Germacrene | 308 |
| Beta-santalene | 259-260 |

TABLE 2
Sesquiterpene Alcohols

| Sesquiterpene Alcohol | B Pt, ° C. at 1 atm. |
|---|---|
| Caryophyllene alcohols | 287-297 |
| Cedrol | 273 |
| Cubenol | 300 |
| Elemol | 289 |
| Beta-eudesmol (Selinenol) | 301-302 |
| 10-epi-gamma-eudesmol | 299-302 |
| Globulol | 293 |
| Guaiol | 309 |
| Isolongifolanol | |
| Cis-lanceol | |
| Cis-nuciferol | |
| Palustrol | 293 |
| Patchouli alcohol | 284 |
| Alpha- and beta-santalol | 302 |
| Spathulenol | 296-298 |
| Widdrol | 303 |

As can be seen from Tables 1 and 2, there is some overlap in the boiling points of the sesquiterpenes and the sesquiterpene alcohols at atmospheric pressure. Despite this overlap, the inventors have discovered that, typically, the sesquiterpenes distill at the lower temperature range and there is little, if any, of one compound type in the other distillate fraction. Although the inventors do not wish to be bound by theory, it is believed that the differences in structures cause the sesquiterpenes and the sesquiterpene alcohols to distill into the separate distilled fractions defined herein.

The inventors have discovered that bicyclic and tricyclic sesquiterpenes better impart organoleptic characteristics than do monocyclic sesquiterpene alcohols. For example, santalene and cedrene are such sesquiterpenes, and santalol and cedrol are examples of such sesquiterpene alcohols. More typically, santalol, cis-nuciferol, and cis-lanceol are especially effective sesquiterpene alcohols.

Examples of sesquiterpenes typically used include bergamotene, santalene, and bisabolene. Examples of sesquiterpene alcohols typically include elemol, cubenol, caryophyllenol, globulol, alpha- and beta-santalol, palustrol, guaiol, cedrol, and widdrol.

Compounds in distilled fractions were identified by gas chromatography/mass spectrometry analysis. Such analysis identifies most compounds in the fraction. This method of analysis typically precludes identification of polyols. However, as noted herein, the nature of the distillation and of the fractions recovered typically afford a good separation between sesquiterpenes and sesquiterpene alcohols. Similarly, the inventors believe that the separation between the distilled fractions recovered herein and the polyols that might be found in essential oil will result in little if any polyol in the distilled fractions described herein.

Typically, the sesquiterpene alcohols identified in Table 2 above impart a woody organoleptic characteristic. These sesquiterpene alcohols typically are added in embodiments of the invention. Most typically, cedrol is added. In other embodiments of the invention, a sesquiterpene alcohol that imparts a citrusy/woody organoleptic characteristic, such as guaiol or globulol, is added. Most typically, cedrol is added.

Most typically, embodiments of the invention incorporate a combination of a sesquiterpene alcohol imparting a woody organoleptic characteristic and a sesquiterpene imparting a citrusy/woody organoleptic characteristic is added. The combination is added to a product comprising a natural high-potency sweetener to ameliorate the different organoleptic and sensate properties and characteristics the product exhibits in view of the presence of the natural high-potency sweetener. In particular, bergamotene and other sesquiterpenes found in bergamot essential oil are used herein.

Examples of sesquiterpene alcohols added in combination include elemol, cubenol, caryophyllene alcohols, globulol, alpha- and beta-santalol, palustrol, guaiol, cedrol, viridiflorol (boiling point 293-4° C.), and widdrol. Examples of sesquiterpenes added in combination include alpha- and beta-bisabolene, beta-caryllophyllene, and beta-elemene.

Typical combinations of a sesquiterpene and a sesquiterpene alcohol include bergamotene with cedrol, bergamotene with alpha- or beta-santalol, bergamotene with palustrol, and bergamotene with guaiol.

A more typically added combination of sesquiterpene alcohols in embodiments of the invention includes the combination of cedrol, which imparts a woody organoleptic characteristic, with viridiflorol, which imparts a tropical organoleptic characteristic.

For convenience, the fractions of essential oil, individual sesquiterpenes, and individual sesquiterpene alcohols, and the combinations thereof, will be referred to as “taste modifying composition.” Thus, embodiments of the invention are directed to a method for ameliorating organoleptic and sensate properties and characteristics imparted to a product by natural high-potency sweetener, the method comprising adding to the product a taste modifying composition selected from the group consisting of a fraction of an essential oil comprising sesquiterpenes and co-distillates that boils and is recovered from the vapors at a temperature between about 50° C. and about 70° C. and at pressure between about 100 Pa and about 1500 Pa; a fraction of an essential oil comprising sesquiterpene alcohols and co-distillates that boils and is recovered from the vapors at a temperature between about 110° C. and about 130° C. and at pressure between about 100 Pa and about 1500 Pa; a sesquiterpene, a sesquiterpene alcohol, and blends thereof. Embodiments of the invention also are directed to products made in accordance with the method.

In accordance with embodiments of the invention, taste modifying composition is added to products comprising natural high-potency sweetener in a quantity sufficient to achieve a concentration of between about 5 parts per billion (ppb) and about 250 ppb. Often, at higher concentrations (i.e., greater than about 250 ppb), taste modifying compositions introduce a bitter sensation when the liquid is imbibed, and often introduce an odor or aroma. Typically, taste modifying composition is added to achieve a concentration between about 10 ppb and about 200 ppb, more typically between about 15 ppb and about 150 ppb, and most typically between about 20 ppb and about 100 ppb.

As described herein, taste modifying compositions may have a significant odor. However, in embodiments of the invention, odor is not to be introduced by the taste modifying composition. Therefore, the concentration of a taste modifying composition is limited to concentrations below the odor threshold therefor. The odor threshold may be affected by the composition of the liquid to which a taste modifying composition has been added. However, with the guidance provided herein, the skilled practitioner will be able to limit the concentration of taste modifying composition to a concentration not greater than the odor threshold in the liquid.

In embodiments of the invention in which a combination of taste modifying compositions is added, the proportion of each component typically is established by balancing the concentrations to obtain a desired result. Thus, the relative concentration of each taste modifying composition in a mixture may range from about 0.1 percent to about 99.9 percent of the total taste modifying composition. Typically, the relative concentration ranges from about 1 percent to about 99 percent of the total taste modifying composition. More typically, each taste modifying composition concentration ranges from about 3 percent to about 97 percent of the total taste modifying composition, and, most typically, between about 5 percent and about 95 percent of the total taste modifying composition.

Similarly, the skilled practitioner recognizes that the composition of an essential oil varies from sample to sample, typically changing seasonally, with the region in which the plant is grown, and in accordance with other variables. Therefore, the compositions of a composite taste modifying compositions that are a distillate fraction are likely to vary. Also, the ingredients of the sweetened composition will affect the concentration of taste modifying composition necessary to obtain a desired result. For example, one type of natural high-potency sweetener, such as Reb A, is likely to require a different concentration of taste modifying composition than is monatin. However, with the guidance provided herein, the skilled practitioner will be able to identify concentrations within the ranges disclosed herein that will provide a desired organoleptic result.

The skilled practitioner is familiar with various expedients to make more convenient the addition of a relatively small amount of an ingredient, such as a taste modifying composition, to a liquid. For example, the taste modifying composition may be dissolved in or diluted with a solvent. The solvent typically is a solvent that does not adversely affect the properties and characteristics of the liquid when used in the amount appropriate to deliver taste modifying composition to the liquid.

One of the ingredients of the beverage may be used as a solvent. Typically, a portion of the ingredient stream is segregated for use in introducing an ingredient such as a taste modifying composition. Ethanol is an example of a solvent for beverages and other liquids, such as mouthwash. Indeed, ethanol is an ingredient in many mouthwashes. Ethanol in an alcoholic beverage also is a suitable solvent or carrier. Propylene glycol is an example of another solvent that may be suitable in a liquid. With the guidance provided herein, the skilled practitioner will be able to identify solvents and circumstances wherein solvent use for this purpose is appropriate.

Thus, in accordance with embodiments of the invention, taste modifying composition is added to a product sweetened with natural high-potency sweetener to ameliorate organoleptic and sensate properties and characteristics introduced by the natural high-potency sweetener that are different from the organoleptic and sensate properties and characteristics introduced by a standard caloric sweetener. The resultant product has, when compared with the composition sweetened with natural high-potency sweetener but without taste modifying composition, a taste that is less bitter, less metallic, or less astringent, has a reduced aftertaste, or does not have a sweetness linger, a delayed onset of sweetness, a cooling effect, or any other effect not introduced by a standard caloric sweetener. The resultant product has a smoother, fuller, more pleasing mouthfeel than does an equivalent beverage to which taste modifying composition had not been added. One or a plurality of these and other improvements is realized in embodiments of the invention.

Products can be evaluated by persons trained in consistent taste evaluation, and by consumers not so trained. Thus, both evaluation of amelioration of the different effects by addition of taste modifying compositions and consumer acceptance can be determined. Indeed, the final arbiter of such judgments is the consumer, as a preferred balance of various tastes is subjective.

The following examples are meant to illustrate embodiments of the invention, not to limit the invention in any way.

### EXAMPLE 1

A lemon-lime carbonated soft drink is made by diluting a volume of lemon-lime beverage formula with 5 volumes of carbonated water. The formula is an aqueous solution that comprises the following ingredients:

| Ingredient | Amount, grams |
|---|---|
| Preservatives | 9 |
| Buffers | 6 |
| Acidulants | 43 |
| Lemon-lime Flavor | q.s. |
| Rebaudioside A | 17.5 |
| Carbonated water | To 5 liters |

The result, a naturally-sweetened diet lemon-lime beverage, has a characteristic lemon-lime flavor, a pH of 3.05, 3.6 volume percent carbonation (CO₂), and 350 ppm Reb A.

The taste of this diet lemon-lime beverage made with natural high-potency sweetener is different from the taste of a comparable beverage naturally sweetened with about 550 grams of sugar, a standard nutritive sweetener.

Each of cedrol, santalene, and bergamotene is separately added to aliquots of the diet lemon-lime beverage in accordance with the following table, wherein ‘X’ notes that a beverage is made at this concentration:

| Taste modifying composition | 10 ppb | 200 ppb |
|---|---|---|
| Cedrol | X | X |
| Santalene | X | X |
| Bergamotene | X | X |

The concentrations of cedrol, santalene, and bergamotene in the flavored beverages are chosen to ensure that the inherent aroma of the taste modifying composition does not alter the aroma and characteristic lemon-lime flavor of the product. The taste modifying composition is introduced to about 333 mL of beverage by adding an appropriate quantity of solution of taste modifying composition in ethanol having a concentration of 1 gram per liter (1 microgram per microliter).

The tastes of the beverages containing taste modifying composition are evaluated by six tasters by comparison to tastes of the comparable beverage without taste modifying compositions. The tasters are provided with ballots that enquire about organoleptic properties and characteristics, including mouthfeel; profile; odor; astringence; off-tastes, such as a bitter taste and bitter after-taste; and sweet linger.

The taste properties of these taste modifying compositions impart a velvety sensory delivery of mouthfeel.

### EXAMPLE 2

A cola carbonated soft drink is made as in Example 1 with the following ingredients:

| Ingredient | Amount, grams |
|---|---|
| Preservatives | 9 |
| Buffers | 6 |
| Acidulants | 17 |
| Cola Flavor | q.s. |
| Rebaudioside A | 17.5 |
| Carbonated water | To 5 liters |

The result, a naturally-sweetened diet cola beverage, has a characteristic cola flavor, a pH of 3.05, 3.6 volume percent carbonation (CO₂), and 350 ppm Reb A.

Without a taste modifying composition, the taste of this diet cola beverage made with natural high-potency sweetener is different from the taste of a comparable beverage.

Each of cedrol, santalene, and bergamotene is separately added to aliquots of the diet cola beverage in accordance with the following table, wherein ‘X’ notes that a beverage is made at this concentration:

| Taste modifying composition | 10 ppb | 200 ppb |
|---|---|---|
| Cedrol | X | X |
| Santalene | X | X |
| Bergamotene | X | X |

The concentrations of cedrol, santalene, and bergamotene in the flavored beverages were chosen to ensure that the inherent aroma of the taste modifying composition did not alter the aroma and characteristic cola flavor of the product. The taste modifying composition was introduced to about 333 mL of beverage by adding an appropriate quantity of solution of taste modifying composition in ethanol having a concentration of 1 gram per liter (1 microgram per microliter).

The tastes of the beverages containing taste modifying composition were evaluated by six tasters by comparison to tastes of the comparable beverage without taste modifying compositions. The same evaluation as used in Example 1 was used to evaluate taste improvement imparted by the taste modifying compositions. The taste properties of these taste modifying compositions included a velvety sensory delivery of mouthfeel. In particular, cedrol at a concentration of 10 ppb imparts a desirable fullness or sugary mouthfeel that ameliorates the thin mouthfeel of typical diet cola sweetened with natural high-potency sweetener.

### EXAMPLE 3

Lemon-lime carbonated soft drink is made in accordance with Example 1. However, instead of individual compound taste modifying compositions, two distillate fractions are used as taste modifying compositions. One taste modifying composition is the distillate fraction of sandalwood boiling between about 115° C. and about 117° C. at 105 Pa. The most prevalent sesquiterpene alcohols in this distillate fraction are the santalols. A second taste modifying composition is the distillate fraction of bergamot boiling between about 60° C. and about 65° C. at 105 Pa. The most prevalent sesquiterpenes in this distillate fraction are alpha- and beta-bergamotene.

Beverages are made by adding 90 ppb of each taste modifying composition to a lemon-lime diet beverage as described in Example 1. A comparative beverage was made by adding 180 ppb of each taste modifying composition distillate cut.

The tastes of these beverages were compared to the taste of an equivalent beverage to which taste modifying compositions was not added. The beverage of the invention having 180 ppb total taste modifying composition concentration and the comparative beverage had a desirable sugary mouthfeel. However, the comparative beverage had an aroma, thus indicating that, at 360 ppb, the concentration of taste modifying compositions was too high.

### EXAMPLE 4

Lemon-lime beverage was made in accordance with Example 1 and cola beverage was made in accordance with Example 2. Cedrol and the distillate fractions described in Example 3 were used in both flavors of beverage as taste modifying compositions at concentrations as set forth in the following table:

| Taste modifying | Concentration, | Lemon-lime flavored | |
|---|---|---|---|
| composition | ppb | beverage | Cola-flavored beverage |
| Cedrol | 180 | Sweeter, woody, | Spicy organoleptic |
| | | improved mouthfeel | characteristic enhanced; |
| | | | mouthfeel improved; |
| | | | rounded, sweeter profile |
| Bergamot | 230 | Fatty, citrusy, fuller | Citrusy, better |
| Distillate Fraction | | mouthfeel; rounded | mouthfeel |
| | | sweetness profile | |
| Sandalwood | 230 | Woody, better | Improved mouthfeel; |
| Distillate Fraction | | mouthfeel | rounded, sweeter profile |
| Bergamot and | 180 ppb each | Sweeter, woody, | Spicy organoleptic |
| Sandalwood | | improved mouthfeel | characteristic enhanced; |
| Distillate Fractions | | | improved mouthfeel; |
| | | | rounded, sweeter profile |
| | 360 ppb total | Undesirable aromatic | Undesirable aromatic |
| | | odor and slightly bitter | odor and slightly bitter |
| | | taste | taste |

The beverages having a total taste modifying composition concentration of 360 ppb are comparative examples.

The tastes of the beverages were compared to the tastes of equivalent beverages of the same flavor devoid of taste modifying compositions. As set forth in the table in this example, addition of taste modifying composition to a beverage sweetened with natural high-potency sweetener improved the taste of the beverage and ameliorated the differences in tastes between the natural high-potency sweetener beverage without taste modifying composition and the equivalent standard beverage.

As can be seen, concentrations of taste modifying composition greater than about 250 ppb introduced an odor and an off-taste (bitter).

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims. For example, the taste of a variety of products can be modified in accordance with embodiments of the invention. Similarly, the taste of products sweetened with different natural high-potency sweeteners can be modified in accordance with embodiments of the invention.

We claim:

1. A method for ameliorating organoleptic and sensate properties and characteristics imparted to a product by natural high-potency sweetener, said method comprising adding to the product a taste modifying composition selected from the group consisting of a fraction of an essential oil comprising sesquiterpenes and co-distillates that boils and is recovered from the vapors at a temperature between about 50° C. and about 70° C. and at pressure between about 100 Pa and about 1500 Pa; a fraction of an essential oil comprising sesquiterpene alcohols and co-distillates that boils and is recovered from the vapors at a temperature between about 110° C. and about 130° C. and at pressure between about 100 Pa and about 1500 Pa; a sesquiterpene; a sesquiterpene alcohol; and blends thereof.

2. A product sweetened with natural high-potency sweetener comprising between about 5 ppb and about 250 ppb of a taste modifying composition selected from the group consisting of a fraction of an essential oil comprising sesquiterpenes and co-distillates that boils and is recovered from the vapors at a temperature between about 50° C. and about 70° C. and at pressure between about 100 Pa and about 1500 Pa; a fraction of an essential oil comprising sesquiterpene alcohols and co-distillates that boils and is recovered from the vapors at a temperature between about 110° C. and about 130° C. and at pressure between about 100 Pa and about 1500 Pa; a sesquiterpene; a sesquiterpene alcohol; and blends thereof.

3. A taste modifying composition comprising a distillate fraction selected from the group consisting of a fraction of an essential oil comprising sesquiterpenes and co-distillates that boils and is recovered from the vapors at a temperature between about 50° C. and about 70° C. and at pressure between about 100 Pa and about 1500 Pa; a fraction of an essential oil comprising sesquiterpene alcohols and co-distillates that boils and is recovered from the vapors at a temperature between about 110° C. and about 130° C. and at pressure between about 100 Pa and about 1500 Pa; and blends thereof.

4. The method of claim 1 wherein the taste modifying composition is a sesquiterpene alcohol selected from the group consisting of caryophyllene alcohols, cedrol, cubenol, elemol, selinenol, 10-epi-gamma-eudesmol, globulol, guaiol, isolongifolanol, palustrol, patchouli alcohol, alpha- and beta-santalol, spathulenol, cis-lanceol, cis-nuciferol, widdrol.

5. The product of claim 2 wherein the taste modifying composition is a sesquiterpene alcohol selected from the group consisting of caryophyllene alcohols, cedrol, cubenol, elemol, selinenol, 10-epi-gamma-eudesmol, globulol, guaiol, isolongifolanol, palustrol, patchouli alcohol, alpha- and beta-santalol, spathulenol, cis-lanceol, cis-nuciferol, and widdrol.

6. The method of claim 1 wherein the taste modifying composition is a combination including a sesquiterpene alcohol selected from the group consisting of caryophyllene alcohols, cedrol, cubenol, elemol, selinenol, 10-epi-gamma-eudesmol, globulol, guaiol, isolongifolanol, palustrol, patchouli alcohol, alpha- and beta-santalol, spathulenol, cis-lanceol, cis-nuciferol, viridiflorol, widdrol, and blends thereof.

7. The product of claim 2 wherein the taste modifying composition is a combination including a sesquiterpene alcohol selected from the group consisting of caryophyllene alcohols, cedrol, cubenol, elemol, selinenol, 10-epi-gamma-eudesmol, globulol, guaiol, isolongifolanol, palustrol, patchouli alcohol, alpha- and beta-santalol, spathulenol, cis-lanceol, cis-nuciferol, viridiflorol, widdrol, and blends thereof.

8. The taste modifying composition of claim 3, further comprising a compound selected from the group consisting of a sesquiterpene, a sesquiterpene alcohol, and blends thereof.

9. The method of claim 1 wherein the pressure is between about 100 and 150 Pa.

10. The product of claim 2 wherein the pressure is between about 100 and 150 Pa.

11. The taste modifying composition of claim 3 wherein the pressure is between about 100 and 150 Pa.

12. The method of claim 6 wherein the pressure is between about 100 and 150 Pa.

13. The product of claim 7 wherein the pressure is between about 100 and 150 Pa.

14. The taste modifying composition of claim 8 wherein the pressure is between about 100 and 150 Pa.

15. The method of claim 1 wherein the taste modifying composition is selected from the group consisting of alpha- and beta-bergamotene, alpha- and beta-bisabolene, alpha-bourbonene, cadinene, beta-caryophyllene, alpha-copaene, beta-cubebene, beta-elemene germacrene, beta-santalene, and blends thereof.

16. The product of claim 2 wherein the taste modifying composition is a sesquiterpene selected from the group consisting of alpha- and beta-bergamotene, alpha- and beta-bisabolene, alpha-bourbonene, cadinene, beta-caryophyllene, alpha-copaene, beta-cubebene, beta-elemene, germacrene, beta-santalene, and blends thereof.

17. The method of claim 1 wherein the taste modifying composition is a combination including a sesquiterpene selected from the group consisting of alpha- and beta-bergamotene, alpha- and beta-bisabolene, alpha-bourbonene, cadinene, beta-caryophyllene, alpha-copaene, beta-cubebene, beta-elemene, germacrene, beta-santalene, and blends thereof.

18. The product of claim 2 wherein the taste modifying composition is a combination including a sesquiterpene selected from the group consisting of alpha- and beta-bergamotene, alpha- and beta-bisabolene, alpha-bourbonene, cadinene, beta-caryophyllene, alpha-copaene, beta-cubebene, beta-elemene, germacrene, beta-santalene, and blends thereof.

19. A method for ameliorating organoleptic and sensate properties and characteristics imparted to a product by artificial high-potency sweetener, said method comprising adding to the product a taste modifying composition selected from the group consisting of a fraction of an essential oil comprising sesquiterpenes and co-distillates that boils and is recovered from the vapors at a temperature between about 50° C. and about 70° C. and at pressure between about 100 Pa and about 1500 Pa; a fraction of an essential oil comprising sesquiterpene alcohols and co-distillates that boils and is recovered from the vapors at a temperature between about 110° C. and about 130° C. and at pressure between about 100 Pa and about 1500 Pa; a sesquiterpene; a sesquiterpene alcohol; and blends thereof.

20. A product sweetened with artificial high-potency sweetener comprising between about 5 ppb and about 250 ppb of a taste modifying composition selected from the group consisting of a fraction of an essential oil comprising sesquiterpenes and co-distillates that boils and is recovered from the vapors at a temperature between about 50° C. and about 70° C. and at pressure between about 100 Pa and about 1500 Pa; a fraction of an essential oil comprising sesquiterpene alcohols and co-distillates that boils and is recovered from the vapors at a temperature between about 110° C. and about 130° C. and at pressure between about 100 Pa and about 1500 Pa; a sesquiterpene; a sesquiterpene alcohol; and blends thereof.
